(19) United States
(12) Patent Application Publication
(10) Pub. No.: US 2022/0370920 A1
(43) Pub. Date: Nov. 24, 2022

(54) ELECTRONIC DEVICE AND METHOD FOR MANAGING CACHE DATA

(71) Applicant: NCSOFT CORPORATION, Seongnam-si (KR)

(72) Inventors: Jungmin MOON, Seongnam-si (KR); Soowan PARK, Seongnam-si (KR); Kidon YEOM, Seongnam-si (KR); Seunghan LEE, Seongnam-si (KR); Junyoung HWANG, Seongnam-si (KR)

(73) Assignee: NCSOFT CORPORATION, Seongnam-si (KR)

(21) Appl. No.: 17/737,365

(22) Filed: May 5, 2022

(30) Foreign Application Priority Data
May 18, 2021 (KR) 10-2021-0063949

(51) Int. Cl. A63F 13/77; A63F 13/71; G06F 9/38; G06F 9/50

(52) U.S. Cl. CPC A63F 13/77; A63F 13/71; G06F 9/3836; G06F 9/5016

(57) ABSTRACT

A non-transitory computer readable medium according to various embodiments store one or more programs include instructions cause, a first processor of an first electronic device to, transmit in response to identification of a first instructions executable by a second processor of the electronic device, at least portion of information associated with the identified first instructions, to a second electronic device, receive a signal associated with the first instructions from the second electronic device, store in response to identification of second instructions distinct from the first instructions from the received signal and executable by the second processor, the second instructions in the memory and transmit in response to identification of a command indicating upload of the first instructions from the received signal, the first instructions executable by the second processor to the second electronic device.

### CROSS-REFERENCE TO RELATED APPLICATION(S)

This application is based on and claims priority under 35 U.S.C. § 120 to Korean Patent Application No. 10-2021-0063949, filed on May 18, 2021, in the Korean Intellectual Property Office, the disclosure of which are incorporated by reference herein their entirety.

### BACKGROUND

### Technical Field

Various embodiments disclosed in this document relate to an electronic device and method for managing cache data.

### Description of Related Art

As communication technology develops, various types of services are emerging. The service may be provided through an electronic device owned by different users, such as a smartphone.

### SUMMARY

When a game service is to be provided using an electronic device, a method for more efficiently managing cache data generated in a state of executing the game service may be required.

A non-transitory computer readable medium according to various embodiments may store one or more programs, wherein the one or more programs may comprise instructions cause, when executed by a first processor of a first electronic device, the first processor to identify first instructions executable by a second processor of the electronic device distinct from the first processor, and stored in a memory of the first electronic device; transmit in response to identification of the first instructions, at least portion of information associated with the identified first instructions, to a second electronic device distinct from the first electronic device; receive a signal associated with the first instructions from the second electronic device, store in response to identification of second instructions distinct from the first instructions from the received signal and executable by the second processor, the second instructions in the memory and transmit in response to identification of a command indicating upload of the first instructions from the received signal, the first instructions executable by the second processor to the second electronic device.

A non-transitory computer readable medium according to various embodiments may store one or more programs, wherein the one or more programs may comprise instructions cause, when executed by at least one processor of a first electronic device including a communication circuit, the first processor to receive by the communication circuit, information generated by the first processor of the second electronic device distinct from the first electronic device; identify first instructions, from the received information, corresponding to a first state among a plurality of states of a game service provided by the second electronic device, wherein the first instructions are stored in the second electronic device and executable by a second processor of the second electronic device distinct from the first processor; identify from a memory of the first electronic device in response to identification of the first instructions stored in the second electronic device, second instructions corresponding to the first state and executable by the second processor; transmit based on at least one of information of the identified first instructions, or the identified second instructions, a signal including a command indicating upload of the first instructions to the second electronic device and substitute in response to receiving of the first instructions from the second electronic device after the transmission of the signal, the second instructions stored in the memory based on the received first instructions.

According to various embodiments, a method of a first electronic device including a display, a memory, a communication circuit, a first processor and a second processor, wherein the first processor and the second processor execute distinct types of instructions may comprise identifying by using the first processor, multiple sets of instructions, which are stored in the memory, and are executable by the second processor among the first processor and the second processor, and for displaying a screen in the display; transmitting, in response to identification of the multiple sets, metadata respectively corresponding to the multiple sets to a second electronic device distinct from the first electronic device by using the communication circuit; and upload, by using the first processor based on a signal transmitted from the second electronic device after transmission of the metadata, at least one of the multiple sets to the second electronic device.

### BRIEF DESCRIPTION OF THE DRAWINGS

FIG. 1 is a diagram illustrating a plurality of electronic devices connected to each other based on a network.

FIG. 2 is a signal flowchart of electronic devices according to various embodiments.

FIG. 3 is a flowchart of an electronic device according to an embodiment.

FIG. 4 is an exemplary diagram for describing cache data stored in a memory by an electronic device according to an embodiment.

FIG. 5 is an exemplary diagram illustrating an operation of exchanging cache data by a plurality of electronic devices according to an embodiment.

FIG. 6 is a flowchart illustrating an operation performed by an electronic device to control a pipeline of a second processor according to an embodiment.

FIG. 7 is a flowchart of an electronic device according to an embodiment.

FIG. 8 is a block diagram of an electronic device based on a cloud environment according to an embodiment.

FIG. 9 is a simplified block diagram of electronic devices according to various embodiments.

### DETAILED DESCRIPTION

The electronic device and the method thereof according to various embodiments can manage cache data generated in a state of executing a game service.

Structural or functional descriptions specified for the embodiments according to the concept of the present invention disclosed in this specification are only exemplified for the purpose of explaining the embodiments according to the concept of the present invention, and the embodiment according to the concept of the present invention may be embodied in various forms and are not limited to the embodiments described herein.

Since the embodiments according to the concept of the present invention may have various changes and may have various forms, the embodiments will be illustrated in the drawings and described in detail. However, this is not intended to limit the embodiments according to the concept of the present invention to specific disclosed forms, and the present invention further includes changes, equivalents, or substitutes of the disclosed forms.

Terms such as first or second may be used to describe various elements, but the elements should not be limited by the terms. The above terms are used only for the purpose of distinguishing one element from other elements, for example, without departing from the scope according to the concept of the present invention, a first element may be named as a second element, Similarly, the second component may also be referred to as the first component.

When a component is referred to as being “connected” or “connected” to another component, it is understood that the component may be directly connected or connected to another component, or other components may exist between the component and another component. However, when it is said that a component is “directly connected” or “directly connected” to another component, it is understood that the other element does not exist in the middle of the component and another component. Expressions describing the relationship between elements, for example, “between” and “between” or “directly adjacent to”, etc., should be interpreted similarly.

The terminology used herein is used only to describe specific embodiments, and is not intended to limit the present invention. The singular expression includes the plural expression unless the context clearly dictates otherwise. In the present disclosure, terms such as “comprise” or “have” are intended to designate that the described feature, number, step, operation, component, part, or combination thereof exists, and it is understood that the existence or addition of one or more other features or numbers, steps, operations, components, parts or combinations thereof is not precluded in advance.

Unless defined otherwise, all terms used herein, including technical or scientific terms, have the same meaning as commonly understood by one of ordinary skill in the art to which this invention belongs. Terms such as those defined in a commonly used dictionary should be interpreted as having a meaning consistent with the meaning in the context of the related art, and should not be interpreted in an ideal or excessively formal meaning unless explicitly defined in the present disclosure.

Hereinafter, embodiments will be described in detail with reference to the accompanying drawings. However, the scope of the present disclosure is not limited or limited by these examples. Equivalent reference numbers in each figure indicates same elements.

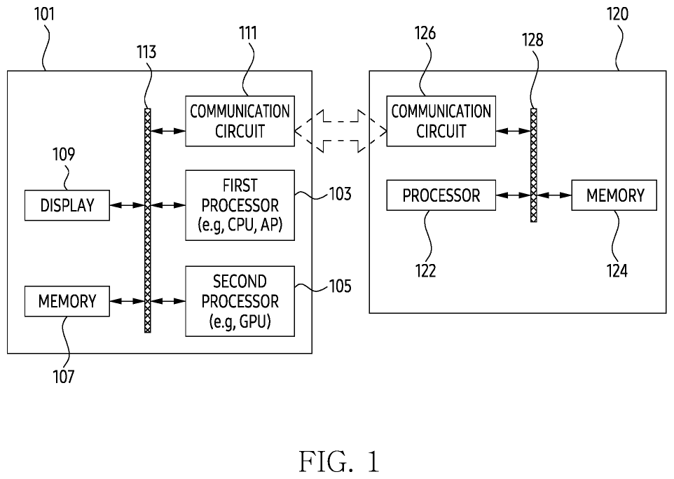

FIG. 1 is a diagram illustrating a plurality of electronic devices connected to each other based on a network. Referring to FIG. 1, an exemplary situation in which the electronic device 101 and the electronic device 120 are connected to each other based on a wired network and/or a wireless network is illustrated.

The wired network may comprise a network such as the Internet, LAN(Local Area Network), WAN(Wide Area Network), ethernet, or a combination thereof. The wireless network may comprise a network such as LTE(Long Term Evolution), 5g NR(New Radio), WiFi(Wireless Fidelity), Zigbee, NFC(Near Field Communication), Bluetooth, BLE(Bluetooth Low-Energy), or a combination thereof. Although the electronic device 101 and the electronic device 120 are illustrated as being directly connected, the electronic device 101 and the electronic device 120 may be indirectly connected through one or more routers and/or AP(Access Points).

Referring to FIG. 1, an electronic device 101 according to an embodiment may be a terminal that is owned by different users. The terminal, for example, may comprise smart accessories such as a PC(Personal Computer) such as a laptop and a desktop, a smartphone, a smartpad, a tablet PC(Personal Computer), a smartwatch, and HMD(Head-Mounted Device). Users of the electronic device 101 may be subscribers of a service provided by the electronic device 120.

Referring to FIG. 1, the electronic device 120 may comprise a server of a service provider. The server may comprise one or more PCs and/or workstations. In an embodiment, the service provider may operate a game service such as MMORPG(Massively Multiplayer Online Role-Playing Game), as a service that provides computer graphics to one or more subscribers. The game service may be related to one or more applications operating in each of the electronic device 101 and/or the electronic device 120.

Referring to FIG. 1, hardware components comprised in the electronic device 101 and the electronic device 120 according to an embodiment are illustrated. Referring to FIG. 1, the electronic device 101 according to an embodiment may comprise at least one of a first processor 103, a second processor 105, a memory 107, a display 109, or a communication circuit 111. The first processor 103, the second processor 105, the memory 107, the display 109, and the communication circuit 111 may be electronically and/or operably coupled with each other by electronical component such as a communication bus 113. The type and/or number of hardware components comprised in the electronic device 101 are not limited to those illustrated in FIG. 1. For example, the electronic device 101 may comprise only some of the hardware components illustrated in FIG. 1.

The processor 103 of the electronic device 101 according to an embodiment may comprise a hardware component for processing data based on one or more instructions. Hardware components for processing data may comprise, for example, ALU(Arithmetic and Logic Unit), FPGA(Field Programmable Gate Array), CPU(Central Processing Unit) and/or AP(Application Processor). The number of processors 103 may be one or more. For example, the processor 103 may have a structure of a multi-core processor such as a dual core, a quad core, or a hexa core.

The second processor 105 of the electronic device 101 according to an embodiment may generate frame data to be provided to the display 109. The second processor 105 may comprise, for example, at least one GPU(Graphic Processing Unit). The second processor 105 may obtain, for example, frame data to be provided to the display 109 based on at least one application and/or system software executed by the first processor 103. In an embodiment, the second processor 105 may generate a screen to be displayed in the display 109 by controlling the DDI and/or graphic memory.)

The memory 107 of the electronic device 101 according to an embodiment may comprise a hardware component for storing data and/or instructions input and/or output to the first processor 103 and/or the second processor 105. The memory 107 may comprise, for example, Volatile Memory such as RAM(Random-Access Memory) and/or Non-Volatile Memory such as ROM(Read-Only Memory). The volatile memory may comprise, for example, at least one of DRAM(Dynamic RAM), SRAM(Static RAM), Cache RAM, PSRAM(Pseudo SRAM). The non-volatile memory may comprise, for example, at least one of PROM(Programmable ROM), EPROM(Erasable PROM), EEPROM(Electrically Erasable PROM), a flash memory, a hard disk, a compact disk, and eMMC(Embedded Multi Media Card).

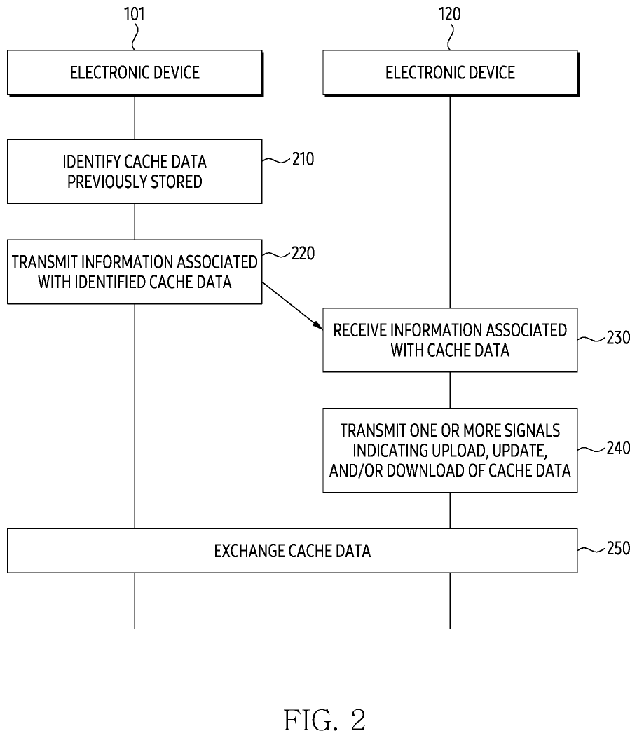

In the memory 107, one or more instructions indicating an operation to be performed by the first processor 103 and/or the second processor 105 may be stored. The set of instructions may be referred to as firmware, operating system, process, routine, sub-routine, and/or application. For example, the electronic device 101 and/or the first processor 103 of the electronic device 101 may execute a set of a plurality of instructions distributed in the form of an application to perform at least one of the operations of FIG. 2 to 3 or 5.

In an embodiment in which the first processor 103 corresponds to a CPU, the first processor 103 may comprise one or more pipelines for performing a plurality of operations necessary for executing a single instruction. Multiple actions required to execute a single instruction may comprise, for example, fetching an instruction, decoding an instruction, and executing an instruction, data required to execute, and/or input and/or output of data generated by the execution. Instructions input to the pipeline may be comprised in a binary file stored in memory 107, may be at least part of the machine language and/or assembly language encoded in binary format.

When the first processor 103 comprises a plurality of pipelines, the first processor 103 may process a plurality of instructions in parallel by simultaneously controlling a plurality of pipelines.). For example, when the first processor 103 comprises M cores and each of the cores comprises N pipelines, the first processor 103 may simultaneously process up to N×M instructions in one clock. Hereinafter, a pipeline comprised in the first processor 103 may be referred to as an instruction pipeline.

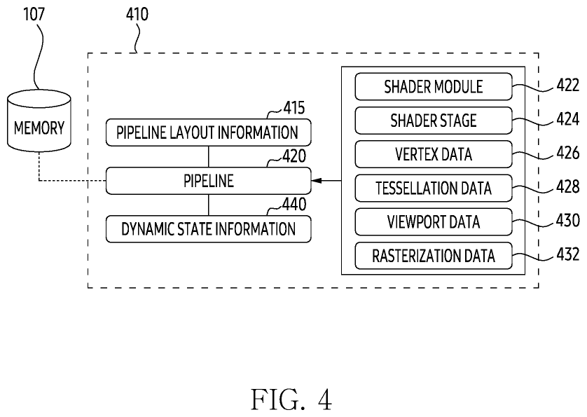

In an embodiment in which the second processor 105 corresponds to a GPU, the second processor 105 may comprise one or more pipelines for performing a plurality of operations necessary for executing instructions related to computer graphics. For example, the pipeline of the second processor 105 may comprise a graphics pipeline or a rendering pipeline for generating a 3D image and generating a 2D raster image from the generated 3D image. The graphics pipeline is comprised in a file stored in memory 107 and may be controlled based on a code written in a shading language. For example, a code written in a shading language may be compiled by the first processor 103. For example, based on the GPU driver executing in the first processor 103, the first processor 103 may compile a shading language. Hereinafter, a set of instructions generated by compiling the code may be referred to as a shader executed by the second processor 105. Information required for controlling the graphics pipeline will be described in detail with reference to FIG. 4. Hereinafter, the pipeline comprised in the second processor 105 may be referred to as a graphics pipeline.

The display 109 of the electronic device 101 according to an embodiment may output visualized information to a user. For example, the display 109 may be controlled by a controller such as the second processor 105 to output visualized information to the user. The display 105 may comprise FPD(Flat Panel Display) and/or electronic paper. The FPD may comprise a LCD(Liquid Crystal Display), a PDP(Plasma Display Panel), and/or one or more LEDs(Light Emitting Diodes). The LED may comprise an OLED(Organic LED).

Although not illustrated, the electronic device 101 according to an embodiment may comprise an output means for outputting in a form other than a visualized form of information. For example, the electronic device 101 may comprise a speaker for outputting an acoustic signal. For example, the electronic device 101 may comprise a motor for providing haptic feedback based on vibration.

The communication circuit 111 of the electronic device 101 according to an embodiment may comprise a hardware component for supporting transmission and/or reception of an electrical signal between the electronic device 101 and the electronic device 120. Although an embodiment in which the electronic device 101 and the electronic device 120 are connected to each other through the communication circuit 111 is illustrated, the embodiment is not limited thereto, and the electronic device 101 may communicate in parallel with a plurality of external electronic devices. The communication circuit 111 may comprise, for example, at least one of a modem (MODEM), an antenna, and an O/E(Optic/Electronic) converter. The communication circuit 111 may support transmission and/or reception of an electrical signal based on various types of protocols such as Ethernet, LAN(Local Area Network), WAN(Wide Area Network), WiFi(Wireless Fidelity), Bluetooth, BLE(Bluetooth Low Energy), ZigBee, LTE(Long Term Evolution), and 5G NR(New Radio).

Referring to FIG. 1, the electronic device 120 according to an embodiment may include at least one of a processor 122, a memory 124, and a communication circuit 126. The processor 122, the memory 124, and the communication circuit 126 may be electrically and/or operatively connected to each other by an electronic device such as a communication bus 128. The type and/or number of hardware components comprised in the electronic device 120 are not limited to those illustrated in FIG. 1. At least one of the hardware components comprised in the electronic device 120 may correspond to a hardware component comprised in the electronic device 101. For example, the processor 122 of the electronic device 120 may correspond to the first processor 103 of the electronic device 101. For example, the memory 124 of the electronic device 120 may correspond to the memory 107 of the electronic device 101. For example, the communication circuit 126 of the electronic device 120 may correspond to the communication circuit 111 of the electronic device 101. Among the descriptions of the hardware components comprised in the electronic device 120, the description overlapping the description of the hardware components included in the electronic device 101 will be omitted.

In a state in which the electronic device 120 according to an embodiment executes one or more instructions stored in the memory 124, the electronic device 120 may execute a function related to an application (e.g., a game application) executed through the electronic device 101. The function may comprise, for example, an operation of providing information to be input to a pipeline executed in the second processor 105 of the electronic device 101. An operation in which the electronic device 120 provides information used to control the pipeline of the second processor 105 of the electronic device 101 will be described in detail with reference to FIG. 2.

The electronic device 120 according to an embodiment may manage information stored in the memory 124 based on a database(DB) stored in the memory 124. In an embodiment, the database may comprise at least one of independent applications executed in the electronic device 120 and/or one or more applications that manage a set of systematized information to be shared between the electronic device 120 and the electronic devices 101 and the information. In the set of information, different information may be combined with each other based on a unit such as a type, column, record, and/or table. The combination of information may be used to add, delete, update, and search information in the database. For example, in a state where the electronic device 120 is provided to the electronic device 101 and searches for information necessary for controlling and generating a pipeline of the second processor 105 of the electronic device 101, the electronic device 120 may further identify information corresponding to the electronic device 101 and/or the second processor 105 and other information combined with the information using a database.

The electronic device 101 and/or the electronic device 120 according to various embodiments may provide a game service to a user of the electronic device 101. In order to improve the user experience of the game service, the game service may operate a loading time of a resource (e.g., a game application) related to the game service to be equal to or less than a specified threshold value and a period of frame data displayed through the display 109 to be equal to or greater than a specified period.

The electronic device 101 according to various embodiments may control the second processor 105 based on one or more instructions being executed in the first processor 103 while executing one or more instructions related to a game service using the first processor 103. For example, by executing one or more instructions, the first processor 103 may convert the code stored in the memory 107 into an instruction executable in the second processor 105. The code may be a code previously written in a shading language. One or more instructions for converting the code from the second processor 105 to an executable instruction may be related to an API(application programming interface)(e.g., an API defined by a shading language) related to the second processor 105. In an embodiment, the first processor 103 may compile the code with instructions executable by the second processor 105.

After the code is compiled by the first processor 103, the first processor 103 may transmit to the second processor 105, one or more commands for the compiled code (e.g., a shader including one or more instructions executable by the second processor 105) to be executed in one or more pipelines of the second processor 105. The one or more commands may comprise, for example, at least one of a command to use the compiled code of one or more pipelines of the second processor 105, a command to initialize a portion (e.g., buffer and/or binary cache) of memory 107 to be used in the process of executing the compiled code of one or more pipelines, a command for obtaining one or more command that are running on the one or more pipelines and are executable by the second processor 105, a command to store one or more instructions acquired above in memory, a command for inputting one or more instructions stored in memory with the one or more pipelines, a command for inputting data into one or more pipelines, or a command for executing compiled code based on input data. The second processor 105 may execute a shader related to the compiled code based on the one or more commands. As the shader is executed, the second processor 105 may generate a computer graphic preset by a code.

A series of operations in which the first processor 103 generates instructions executable by the second processor 105 and instructs the instruction generated by the second processor 105 to be executed may be performed in a state in which the first processor 103 executes a game application. For example, in order to create and/or modify a virtual space such as a stage in a game or to generate a video played under a specified condition such as cut-scene and/or event scene, the first processor 103 may perform the operation. The first processor 103 may compile the code stored in the memory 107 to obtain instructions executable by the second processor 105. In the state of compiling the code, the first processor 103 may display a preset UI on the display 109 to induce a standby of the user, such as a loading screen, until completion of the compiling of the code is identified.

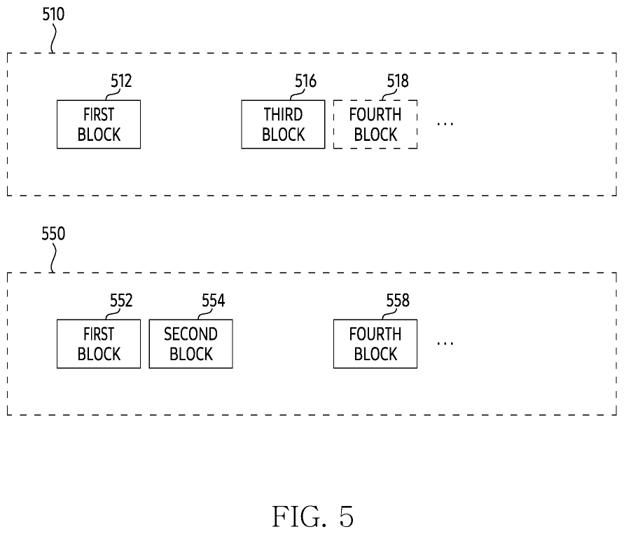

The electronic device 101 according to an embodiment may store the code compiled by the first processor 103, for example, one or more instructions executable by the second processor 105, in the memory 107. The electronic device 101 may store cache data including one or more instructions executable by the second processor 105 in the memory 107. In the cache data, information to be input to one or more pipelines of the second processor 105 controlled based on the one or more instructions may be further stored together with the one or more instructions. Information comprised in the cache data will be described in detail with reference to FIG. 4. In an embodiment, the electronic device 101 may be used by a game application and may disperse all instructions executable by the second processor 105 to a plurality of blocks of cache data. For example, the electronic device 101 may generate cache data comprising a portion of instructions executable by the second processor 105. Cache data stored in the electronic device 101 will be described in detail with reference to FIG. 5.

When the pipeline of the second processor 105 is controlled again based on the code after storing the one or more instructions and/or cache data in the memory 107, the first processor 103 may bypass an operation of compiling the code in the first processor 103 based on cache data stored in the memory 107. By bypassing the operation of compiling the code, the first processor 103 may reduce a time for displaying a preset UI inducing a user's standby on the display 109.

The electronic device 120 according to an embodiment may comprise a database for managing cache data generated by the electronic device 101. In an embodiment in which the electronic device 120 comprises a server of a service provider, the electronic device 120 may obtain cache data from an external electronic device owned by each of a plurality of users, such as the electronic device 101. The acquired cache data may be stored in the database together with information of the external electronic device that generated the cache data. The cache data stored in the electronic device 120 may be provided to another external electronic device distinct from the external electronic device providing the cache data and may be used for bypassing compiling of other external electronic devices. An operation in which the electronic device 120 and the electronic device 101 exchange cache data will be described in detail with reference to FIGS. 2 to 3 and 5 to 8. Exchange of cache data may enable partial exchange of shaders related to game applications as instructions executable by the second processor 105 are partially stored in cache data. The partial exchange of shaders may cause the electronic device 101 and the electronic device 120 to efficiently use network resources.

FIG. 2 is a signal flowchart of electronic devices according to various embodiments. Each of the electronic device 101 and the electronic device 120 of FIG. 2 may comprise the electronic device 101 and the electronic device 120 of FIG. 1. Each of the operation of the electronic device 101 and the operation of the electronic device 120 illustrated in FIG. 2 may be performed by the first processor 103 and the processor 122 of FIG. 1.

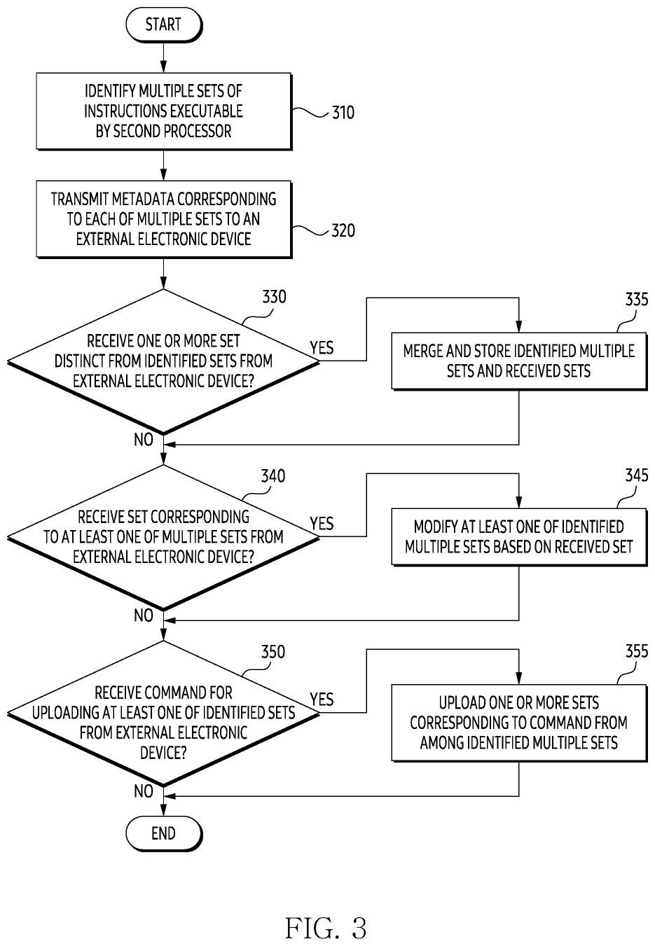

Referring to FIG. 2, in operation 210, the electronic device 101 according to an embodiment may identify cache data previously stored in a memory (e.g., the memory 107 of FIG. 1). The electronic device 101 according to an embodiment may identify cache data comprising information related to a pipeline (e.g., a graphic pipeline) of the second processor (e.g., the second processor 105 of FIG. 1) using the first processor (e.g., the first processor 103 of FIG. 1). For example, the cache data may be a set of information that may be input to the second processor independently from compiling. For example, the cache data may be a set of information that is able to initialize a shader in the second processor without compiling, including a compiled instruction. The information will be described in detail with reference to FIG. 4. The operation of identifying the cache data by the electronic device 101 may comprise information describing the cache data, for example, the operation of identifying metadata corresponding to cache data. The metadata will be described in detail with reference to FIG. 3.

The operation of identifying cache data by the electronic device 101 according to an embodiment may be performed in response to a user input of executing a preset application (e.g., an application installed in the electronic device 101 to provide a game service). In a state in which the preset application is executed by the electronic device 101, the electronic device 101 according to an embodiment may identify cache data based on operation 210. For example, in response to a specified event and/or entering into a specified state of the specified application, the electronic device 101 may identify cache data.

The preset event and/or the preset state causing identification of cache data by the electronic device 101 may comprise, for example, at least one of an event called during initializing the application in response to a user input running the application (e.g., an onStartup event in the Android operating system), an event called when the application execution is at least temporarily stopped (e.g., onPause events on Android operating systems), or an event called when a specified condition is satisfied.

Referring to FIG. 2, in operation 220, the electronic device 101 according to an embodiment may transmit information associated with the identified cache data to the electronic device 120. The information related to the cache data is information for describing the cache data and, for example, may comprise metadata corresponding to the cache data. The metadata may comprise an identifier of an application corresponding to the cache data. The metadata may comprise at least one of an identifier of the second processor capable of executing cache data, a type, a vendor, a firmware version related to the second processor, or a driver version. The metadata may comprise a hash value of cache data. The hash value may be used to verify integrity of cache data. In an embodiment, the hash value may comprise a parameter indicating a frequency of use of cache data by a second processor.

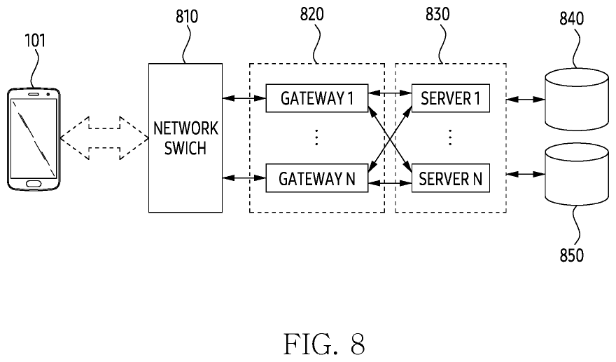

The electronic device 101 may establish a connection with the electronic device 120 through a network to transmit information based on operation 220. For example, the electronic device 101 may establish a connection with the electronic device 120 based on a network identifier preset by an application executing in the electronic device 101. For example, the electronic device 101 may establish a connection with the electronic device 120 in response to acquisition of information (e.g., ID, password, information encrypted by an electronic signature, and/or biometric information) for login from a user. Although the electronic device 120 is illustrated as a single electronic device in FIGS. 1 to 2, as illustrated in an embodiment of FIG. 8, the electronic device 120 may comprise a system in which a plurality of servers and/or databases are connected to each other.

Referring to FIG. 2, in operation 230, the electronic device 120 according to an embodiment may receive information associated with cache data from the electronic device 101. Receiving the information by the electronic device 120 may be performed after transmission of the information by the electronic device 101 based on operation 220. For example, the electronic device 120 may receive metadata corresponding to cache data from the electronic device 101. The metadata may comprise one or more parameters describing cache data.

Referring to FIG. 2, in operation 240, the electronic device 120 according to an embodiment may transmit one or more signals indicating upload, update, and/or download of cache data to the electronic device 101. The electronic device 120 according to an embodiment may determine whether to transmit other cache data distinct from the cache data stored in the electronic device 101 based on the received metadata. When the other cache data is different from the cache data stored in the electronic device 101, the electronic device 120 may transmit a signal indicating download of the cache data to the electronic device 101. When the other cache data is the updated version of cache data than the cache data stored in the electronic device 101, the electronic device 120 may transmit a signal indicating the update of the cache data to the electronic device 101.

The electronic device 120 according to an embodiment may determine whether to receive cache data stored in the electronic device 101 based on the received metadata. For example, when the cache data stored in the electronic device 101 is a more updated version of cache data than the cache data stored in the electronic device 120, the electronic device 120 may transmit a signal indicating uploading of the cache data to the electronic device 101.

In an embodiment, the electronic device 120 may inspect the integrity and/or sufficiency of cache data stored in the electronic device 101 based on the received metadata. The sufficiency is an attribute indicating whether cache data is necessary for execution of a specified application (e.g., a game application) being executed in the electronic device 101. The integrity is an attribute indicating whether cache data is falsified. When integrity and/or sufficiency are not satisfied, the electronic device 120 may transmit a signal indicating the update of cache data to the electronic device 101.

Referring to FIG. 2, in operation 250, the electronic device 101 and the electronic device 120 according to an embodiment may exchange cache data stored in a memory. The exchange of the cache data may be performed by one or more signals transmitted from the electronic device 120 to the electronic device 101 based on operation 240. As described in operation 240, the electronic device 120 may transmit a signal indicating at least one of downloading, uploading, or updating cache data to the electronic device 101. The exchange of cache data between the electronic device 101 and the electronic device 120 may comprise at least one of downloading, uploading, or updating the cache data.

The electronic device 120 according to an embodiment may transmit to the electronic device 101, a signal indicating download of the cache data when the other cache data is different from the cache data stored in the electronic device 101. The electronic device 120 according to an embodiment may transmit to the electronic device 101, a signal indicating an update of the cache data when the other cache data is an updated version of cache data than the cache data stored in the electronic device 101. The signal indicating the download and/or update of the cache data may comprise cache data stored in the electronic device 120.

In response to reception of a signal comprising cache data, the electronic device 101 may complete storage and/or update of cache data based on the cache data comprised in the received signal. The electronic device 101 according to an embodiment may merge and store cache data comprised in the received signal into cache data stored in the memory.

The electronic device 120 according to an embodiment may determine whether to receive cache data stored in the electronic device 101 based on the received metadata. For example, when the cache data stored in the electronic device 101 is a more updated version of cache data than the cache data stored in the electronic device 120, the electronic device 120 may transmit a signal indicating uploading of the cache data to the electronic device 101.

In response to reception of a signal indicating uploading of cache data, the electronic device 101 may transmit cache data corresponding to the received signal to the electronic device 120. The cache data transmitted by the electronic device 101 to the electronic device 120 may be cache data not stored in the memory (e.g., the memory 124) of the electronic device 120 or cache data having an updated version than the cache data stored in the memory of the electronic device 120. The electronic device 120 according to an embodiment may obtain cache data from electronic devices of subscribers of a game service comprising the electronic device 101 by using a signal indicating upload. The electronic device 120 may maintain the cache data of the entire electronic devices of subscribers of the game service in the latest state by using the obtained cache data.

Since the cache data comprises instructions executable in the second processor, that is, instructions compiled, the electronic device 101 may execute a shader corresponding to the cache data faster based on the cache data. As the shader corresponding to the cache data is rapidly executed, compiling in the first processor may be bypassed in a state of executing the game application. As the compiling of the first processor is bypassed, the electronic device 101 may reduce a time for displaying a preset UI inducing the user's waiting, such as a loading screen.

FIG. 3 is a flowchart of an electronic device according to an embodiment. The electronic device of FIG. 3 may comprise the electronic device 101 of FIGS. 1 and/or 2. For example, at least one of the operations of FIG. 3 may be performed by the electronic device 101 and/or the first processor 103 of FIG. 1. At least one of the operations of FIG. 3 may be related to at least one of the operations of FIG. 2.

Referring to FIG. 3, in operation 310, the electronic device according to an embodiment may identify a plurality of sets of instructions executable by the second processor. The electronic device according to an embodiment may perform operation 310 similar to operation 210 of FIG. 2. The electronic device according to an embodiment may identify instructions stored in the memory of the electronic device and executable by a second processor distinct from the first processor by using a first processor such as a CPU. The second processor may be a processor capable of processing instruction of a type different from that of the first processor, such as a GPU.

The electronic device according to an embodiment may identify multiple sets of instructions for displaying a screen on the display, which may be executed by the second processor among the first processor and the second processor using the first processor. Each of the plurality of sets may comprise at least one of instructions corresponding to one or more shaders included in the pipeline of the second processor or information input to the shader when executed by the second processor. Instructions comprised in the set and executable by the second processor are instructions compiled by the first processor before generating the set and may cause shader execution within the second processor by bypassing the compiling.

The set of instructions executable by the second processor may be referred to hereinafter as cache data and blocks. For example, the electronic device may identify instructions executable by the second processor in memory, within a block corresponding to one of the different states of the game service provided based on at least one or more programs. The block may further comprise information input to the pipeline of the second processor corresponding to the instructions when the instructions comprised in the block are executed by the second processor. For example, the block may comprise one or more instructions to be input to the second processor for execution of the shader and information necessary for execution of the instructions.

Referring to FIG. 3, in operation 320, the electronic device according to an embodiment may transmit metadata corresponding to each of a plurality of sets to an external electronic device. In response to identification of a plurality of sets in operation 310, the electronic device according to an embodiment may transmit metadata corresponding to each of the plurality of sets to an external electronic device (e.g., the electronic device 120 of FIGS. 1 to 2) using a communication circuit. The electronic device according to an embodiment may transmit at least a portion of metadata to an external electronic device.

Metadata transmitted by the electronic device to an external electronic device according to an embodiment may comprise information related to instructions included in each of a plurality of sets. For example, the information may comprise at least one of the size of instructions, the time at which instructions are compiled to be executable by the second processor of the electronic device, the identifier of content corresponding to instructions, or the frequency at which instructions are used by the second processor. Metadata transmitted by an electronic device to an external electronic device according to an embodiment may comprise information for indicating at least one of a set size corresponding to metadata among a plurality of sets or a version related to a screen to be displayed on the display when the set corresponding to metadata is executed by a second processor. The metadata may comprise at least one of an identifier of content corresponding to instructions related to metadata or a frequency at which instructions related to metadata are used by a second processor. For example, at least one of the identifier or the frequency of the content may be encoded in a hash value of metadata.

The electronic device according to an embodiment may transmit metadata including at least one of the parameters illustrated in Table 1 to an external electronic device.

TABLE 1

| Number | parameter name |
|---|---|
| (1) | application identifier |
| (2) | device model name |
| (3) | second processor model name |
| (4) | operating system identifier |
| (5) | graphics pipeline API header version |
| (6) | graphics pipeline API vendor version |
| (7) | device identifier |
| (8) | cache data identifier |
| (9) | hash value |
| (10) | cache data size |

Referring to Table 1, (1) application identifier may comprise a parameter for identifying an application causing generation of cache data. When the electronic device according to an embodiment executes an application for providing a game service, the application identifier may comprise information related to the game application executed in the electronic device, for example, at least one of a name of a game application, a version, or a name of a manufacturer of a game application. (2) device model name of Table 1 may comprise a parameter indicating a name given to the electronic device by a vendor producing the electronic device. (3) second processor model name of Table 1 may comprise a parameter indicating a name given to the second processor by a vendor producing the second processor (e.g., the second processor 105 of FIG. 1) comprised in the electronic device. (4) operating system version of Table 1 may comprise information related to the operating system running in the electronic device, for example, at least one of a name of an operating system, a version, and a name of a manufacturer. Each of the (5) graphic pipeline API header version and (6) graphic pipeline API vendor version of Table 1 may correspond to a parameter representing the header and vendor of the API used to generate cache data. (7) device identifier of Table 1 may comprise a parameter indicating an identifier uniquely assigned to the electronic device.

(8) cache data identifier of Table 1 may comprise a parameter for identifying cache data. One or more blocks of cache data may be generated by a single application running in the electronic device. The cache data identifier may comprise at least one of an identifier uniquely allocated to each of a plurality of blocks of cache data stored in the electronic device or a time for generating cache data (e.g., compiling time of instructions comprised in cache data). In an embodiment, each of the plurality of blocks may have a different version. (9) hash value of Table 1, for example, is an integer with a size of 32 bits and may comprise a result of applying a hash function to cache data. The hash value may further comprise information indicating at least one of a frequency of use of cache data or a state of an application corresponding to cache data (e.g., an identifier of a scene in which cache data is used). The hash value may be used to verify the integrity of the cache data. (10) cache data size of Table 1, may comprise a parameter indicating the size of a block or set corresponding to the cache data.

After transmitting at least, a part of the metadata to the external electronic device based on operation 320, the electronic device may receive a signal related to instructions executable by the second processor from the external electronic device. For example, the electronic device may receive a signal for exchanging a plurality of sets of instructions executable by a second processor between the electronic device and the external electronic device from an external electronic device. The signal may comprise the signal of operation 240 of FIG. 2. At least one of the operations 330, 335, 340, 345, 350, and 355 of FIG. 3 may be performed by an electronic device in response to reception of the signal from an external electronic device.

Referring to FIG. 3, in operation 330, the electronic device according to an embodiment may determine whether one or more sets distinct from the identified sets are received from an external electronic device. For example, the external electronic device may transmit a signal comprising a command for adding one or more sets of instructions executable by the second processor to the electronic device. The signal may comprise one or more sets distinct from the sets identified in the electronic device based on operation 310.

In response to receiving one or more sets distinct from the identified sets from the external electronic device (330-yes), in operation 335, the electronic device according to an embodiment may merge and store a plurality of identified sets and the received sets. After transmitting metadata based on operation 320, The electronic device according to an embodiment may download a set distinct from a plurality of sets identified in operation 310 as a set of instructions executable by the second processor of the electronic device using the first processor of the electronic device based on a signal received from the external electronic device. From a signal received from an external electronic device, the other instructions may be stored in the memory in response to identification of other instructions that may be executed by a second processor and distinct from a plurality of instructions stored in the electronic device. For example, the electronic device may merge and store the other instructions with a plurality of instructions stored in the electronic device.

The set of instructions that the electronic device receives from the external electronic device according to an embodiment is a set independent of a plurality of sets of instructions stored in the electronic device, for example, may include instructions that are relatively less used than the plurality of sets. The set of instructions that the electronic device receives from the external electronic device is a set corresponding to a state distinct from a state of an application corresponding to each of a plurality of sets stored in the electronic device, for example, may be a set corresponding to a state in which an application is expected to enter.

Referring to FIG. 3, in operation 340, the electronic device according to an embodiment may determine whether a set corresponding to at least one of a plurality of sets is received from an external electronic device. For example, the external electronic device may transmit a signal comprising a command for updating a set of instructions executable by the second processor to the electronic device. The signal may comprise a set in which at least one of the sets identified in the electronic device is updated based on operation 310.

In response to receiving a set corresponding to at least one of a plurality of sets from an external electronic device (340-Yes), in operation 345, the electronic device according to an embodiment may modify at least one of the plurality of identified sets based on the received set. In response to identification of instructions executable by a second processor within a signal received from an external electronic device, the electronic device according to an embodiment may replace instructions stored in memory based on the identified instructions. In response to identification of a command for updating instructions stored in the electronic device from a signal received from the external electronic device, the electronic device according to an embodiment may replace instructions stored in the electronic device based on instructions comprised in the signal.

The set of instructions received by the electronic device from an external electronic device may further include information necessary to execute the instruction-based shader included in the set on the second processor. The size of the set of instructions received by the electronic device from an external electronic device may correspond to the set and may be larger than the size of the set stored in the electronic device. The version of the set of instructions received by the electronic device from an external electronic device may correspond to the set and have a later version than the version of the set stored in the electronic device.

The electronic device according to an embodiment may determine whether to modify the set stored in the electronic device by using the size and/or version of the received instruction set. For example, when the size of the set of instructions received by the electronic device is larger than the size of the set stored in the electronic device, the electronic device may modify the set stored in the electronic device based on the set of instructions received. For example, when the version of the set of instructions received by the electronic device is a later version than the version of the set stored in the electronic device, the electronic device may modify the set stored in the electronic device based on the set of instructions received.

Referring to FIG. 3, in operation 350, the electronic device according to an embodiment may determine whether a command for uploading at least one of the identified sets is received from an external electronic device. For example, an external electronic device may send a command to upload at least one set to the electronic device in response to identification of a set having a later version than a set stored in an external electronic device or a set having a larger size than a set stored in an external electronic device, among a plurality of sets of instructions stored in the electronic device.

When a command for uploading at least one of the identified sets is received from an external electronic device (350-Yes), in operation 355, the electronic device according to an embodiment may upload one or more sets corresponding to the command among a plurality of identified sets. After transmitting the metadata of operation 320, the electronic device according to an embodiment may upload at least one of a plurality of sets to the external electronic device using a first processor based on a signal received from the external electronic device. The set of instructions uploaded by the electronic device to the external electronic device may be a set corresponding to a command received from the external electronic device. From a signal received from an external electronic device, the electronic device may transmit instructions executable by the second processor to the external electronic device in response to identification of a command indicating upload of instructions executable by the second processor.

At least one of the operations described in FIG. 3 may be performed based on any one of a plurality of threads generated by a preset application (e.g., a game application) executed by the first processor of the electronic device. For example, the electronic device according to an embodiment may perform at least one of the operations of FIG. 3 by using another thread distinct from the main thread of the game application. For example, the operation of the electronic device uploading a set of instructions executable by the second processor to the external electronic device based on the operation 355 may be performed based on another thread that is running in the first processor and is distinct from the main thread of the game application.

Based on FIG. 3, the electronic device and the external electronic device may complete the exchange of a set of instructions executable by the second processor. The electronic device according to an embodiment may execute a shader related to an application running in the electronic device using at least one of the sets of exchanged instructions. For example, in response to entering a preset state corresponding to instructions stored in a memory and executable by a second processor among a plurality of states of a game service provided at least based on one or more programs, the first processor of the electronic device according to an embodiment may transmit a signal indicating execution of a pipeline (or shader) based on the instructions to the second processor while transmitting a set of instructions stored in the memory. The entering into the preset state may be performed in response to a call of an API for compiling the instructions stored in a memory by the first processor of the electronic device. For example, the first processor of the electronic device may transmit a set of instructions stored in the memory to the second processor in a state of bypassing the compiling despite the call of the API for compiling the instructions.

In a state of using the set of instructions stored in the memory by the second processor, the electronic device may modify information related to the number of executions of the pipeline based on the set of instructions in the memory. For example, the electronic device may modify a parameter such as the frequency of use of cache data stored in the hash value of Table 1. The frequency of use may determine a state in which an application running in the electronic device is expected to enter and may cause download of cache data corresponding to a state predicted from an external electronic device. Since the download of cache data corresponding to the predicted state is performed in advance, the electronic device may bypass compiling by the first processor and input the downloaded cache data to the second processor in response to entering the predicted state. While inputting the downloaded cache data to the second processor, the electronic device may request execution of a shader based on the input cache data. By bypassing compiling, the time spent on executing the shader may be reduced.

FIG. 4 is an exemplary diagram for describing cache data 410 stored in a memory by an electronic device according to an embodiment. The electronic device of FIG. 4 may comprise the electronic device 101 of FIGS. 1 and/or 2. The memory of FIG. 4 may comprise the memory 107 of FIG. 1.

Referring to FIG. 4, the cache data 410 stored in the electronic device may comprise instructions executable by the second processor (e.g., the second processor 105 of FIG. 1) of the electronic device and may comprise a pipeline 420 to be input from the second processor. The pipeline 420 may mean a shader to be executed using the graphics pipeline of the second processor. The pipeline 420 is instructions executable by the second processor and may comprise instructions compiled before the cache data 410 is stored in memory.

The electronic device according to an embodiment may further store information related to the pipeline 420 in the cache data 410. The electronic device according to an embodiment may store information necessary for generating (i.e., rendering) frame data through execution of the shader in the cache data 410. For example, the electronic device may store pipeline layout information 415 indicating the layout of the pipeline 420 together with instructions executable by the second processor in the cache data 410. The pipeline layout information 415 may represent a combination of one or more operations related to execution of the pipeline 420 among a plurality of operations supported by the graphic pipeline of the second processor.

For example, the electronic device may store dynamic state information 440 of the pipeline 420 together with instructions executable by the second processor in the cache data 410. The dynamic state information 440 may comprise information necessary for changing the state of the shader without changing or re-inputting the shader being executed in the graphic pipeline. The dynamic state information 440 may comprise at least one of a view port, a scissor test, a blending constant, a stencil reference, a depth bound, or a depth bias.

The electronic device according to an embodiment may store information to be input to the second processor in a state in which the pipeline 420 is executed in the second processor in the cache data 410. The information to be input to the second processor may comprise, for example, information to be processed by the shader, such as material or renderer state. Referring to FIG. 4, as information to be input to the second processor, the electronic device may store at least one of the shader module 422, the shader stage 424, the vertex data 426, the tessellation data 428, the viewport data 430, or the rasterization data 432 in the cache data 410. Shader module 422 may mean a set of instructions executable by the second processor. The shader stage 424 may mean a set of instructions that are executable by the second processor and are independent of the platform, such as spir-V. The vertex data 426 may comprise information input to the shader and related to a point based on 3D coordinates. For example, the vertex data 426 may comprise a vertex input description. For example, the vertex data 426 may comprise parameters indicating a state of the vertex, such as information for binding the vertex to the pipeline, a format of the vertex, a vertex stride, and an input rate. The tessellation data 428 may comprise information for dividing a plane having a point based on three-dimensional coordinates as a vertex. The viewport data 430 is an area to be output to a display (e.g., display 109) of an electronic device, and may comprise information indicating an area viewable by at least a part of the display among spaces based on the three-dimensional coordinates. The rasterization data 432 may comprise information for generating a two-dimensional image in which a space based on three-dimensional coordinates is projected.

Materials such as vertex data 426, tessellation data 428, viewport data 430, and rasterization data 432 may correspond to information input to the shader while the shader based on the pipeline 420 is executed in the second processor. As the cache data 410 comprises both a shader to be executed in the second processor and information to be input to the shader, after being input to the second processor, the cache data 410 may be executed immediately after being input to the second processor by bypassing the compiling by the first processor. After the cache data 410 is input by the second processor, the second processor may generate frame data to be output through the display without requiring additional data input. As the cache data 410 comprises both a shader to be executed in the second processor and information to be input to the shader, the electronic device according to an embodiment may reduce a time delay occurring while generating the shader and inputting the information to the shader.

The electronic device according to an embodiment may manage cache data 410 stored in the memory 107 based on a block. A single block stored in the electronic device may correspond to any one of a plurality of states preset by a preset application such as a game application. In an embodiment, the state may correspond to a part of a virtual space defined by a game application. For example, when a character of a user using a game application enters a part of the virtual space, the electronic device according to an embodiment may perform rendering of the virtual space using the cache data 410. For example, the first processor of the electronic device may store blocks of cache data 410 corresponding to each of the different parts of the virtual space in memory 107, and in response to switching between the parts by a user using a game application, the second processor of the electronic device may selectively fetch any one of the blocks of cache data 410 from the memory 107.

In an embodiment, a state corresponding to each of the blocks of the cache data 410 stored in the memory 107 may correspond to a video played by a game application. For example, when the electronic device reproduces a video comprising a plurality of cut-scene based on a game application, each of the blocks of the cache data 410 may correspond to each of the plurality of cut-scenes. In a state of sequentially reproducing a plurality of cut-scenes, the electronic device may fetch blocks of the cache data 410 from the memory 107 based on the order of the cut-scenes being reproduced.

As the electronic device according to various embodiments manages the cache data 410 based on the plurality of blocks, while efficiently using the network by selectively updating a plurality of blocks, the electronic device may reduce a delay generated by downloading and/or generating cache data 410. Hereinafter, an operation in which the electronic device manages the cache data 410 based on a plurality of blocks will be described in detail with reference to FIG. 5.

FIG. 5 is an exemplary diagram illustrating an operation of exchanging cache data by a plurality of electronic devices according to an embodiment. The cache data of FIG. 5 may comprise the cache data 410 of FIG. 4. The operation of exchanging the cache data of FIG. 5 may be related to at least one of the operations of FIGS. 2 to 3.

Referring to FIG. 5, blocks of cache data stored in the memory 510 of the first electronic device are illustrated. Referring to FIG. 5, blocks of cache data stored in the memory 550 of the second electronic device are illustrated. Each of the first electronic device and the second electronic device of FIG. 5 may correspond to the electronic device 101 and the electronic device 120 of FIG. 1. Each of the blocks of cache data may be distributed within the memories 510 and 550 by applying a hash function to a hash value of a shader corresponding to a game application. The first electronic device according to an embodiment may execute an application corresponding to the cache data in a state in which it does not have all blocks of the cache data. In the example of FIG. 5, the first electronic device may execute an application in a state in which only the first block 512, the third block 516, and the fourth block 518 are stored in the memory 510 among the first to fourth blocks of cache data.

The first electronic device to the second electronic device may perform at least one of the operations described in FIGS. 2 to 3. The first electronic device according to an embodiment may transmit metadata for each of the first block 512, the third block 516, and the fourth block 518 of cache data stored in the memory 510 to the second electronic device. For example, the metadata may comprise information for describing each of the first block 512, the third block 516, and the fourth block 518 based on at least one of the parameters in Table 1.

In response to receiving metadata for each of the first block 512, the third block 516, and the fourth block 518, the second electronic device may compare cache data stored in the first electronic device with cache data stored in the second electronic device. Comparison of cache data may be performed independently in each of the blocks of cache data. In the example of FIG. 5, the second electronic device may store only the first block 552, the second block 554, and the fourth block 558 among the first to fourth blocks of cache data in the memory 550. The second electronic device may compare blocks of cache data stored in the memory 550 and blocks of cache data stored in the memory 510 of the first electronic device identified by metadata, respectively.

As the comparison of cache data is performed independently in each of the blocks of cache data, the exchange of cache data between the first electronic device and the second electronic device may be performed independently in each of the blocks of cache data. For example, when the first block 512 of cache data stored in the first electronic device and the first block 552 of cache data stored in the second electronic device are identical to each other, exchange of the first blocks 512 and 552 of cache data between the first electronic device and the second electronic device may not be performed. Independently of the exchange of the first blocks 512 and 552 is not performed, the second electronic device may perform exchanging other blocks of cache data. For example, when the second block 554 of cache data stored in the memory 550 of the second electronic device is not stored in the first electronic device, the second electronic device may transmit a command indicating the download of the second block 554 to the first electronic device. The command may be transmitted to the first electronic device together with the second block 554.

In the example of FIG. 5, a second block 554 of cache data that causes the first electronic device to download is a block selected by the second electronic device according to an embodiment and may be a block that is most likely to be executed by the second processor (e.g., the second processor 105 of FIG. 1) of the first electronic device among blocks not stored in the first electronic device. For example, the second electronic device may select a block to be transmitted to the first electronic device based on the frequency of use, priority, and/or order of use of each of the blocks of cache data. For example, in a state in which the first electronic device storing only the first block 512, the third block 516, and the fourth block 518 of cache data is identified, the second electronic device may transmit a block having a higher frequency of use than the first block 512, the third block 516, and/or the fourth block 518, or a block executed adjacent to the first block 512, the third block 516, and/or the fourth block 518 to the first electronic device.

When the first electronic device identifies a block of cache data not stored in the memory 550 of the second electronic device, the second electronic device may transmit a command indicating uploading of the identified block to the first electronic device. In the example of FIG. 5, the second electronic device may identify a third block 516 of cache data not stored in the memory 550 based on metadata received from the first electronic device. In response to identification of the third block 516 not stored in the memory 550, the second electronic device may transmit a command indicating uploading of the third block 516 to the first electronic device. In response to receiving the command indicating the upload, the first electronic device may transmit the third block 516 to the second electronic device. The second electronic device may store the received third block 516 in combination with other blocks (e.g., the first block 552, the second block 554, and the fourth block 558) of cache data stored in the memory 550. The second electronic device may transmit the stored third block 516 to another electronic device distinct from the first electronic device.

The exchange of blocks of cache data between the first electronic device and the second electronic device may cause selective updates in the blocks. For example, the second electronic device may identify the version and/or size of each of the first block 512, the third block 516, and the fourth block 518 stored in the first electronic device based on metadata received from the first electronic device. The identified version and/or size may be used to compare blocks of cache data stored in each of the first electronic device and the second electronic device.

For example, when the size of the fourth block 518 stored in the first electronic device is smaller than the size of the fourth block 558 stored in the second electronic device, the second electronic device may transmit a command indicating the update of the fourth block 518 to the first electronic device. For example, when the version of the fourth block 518 stored in the first electronic device is the previous version of the version of the fourth block 558 stored in the second electronic device, the second electronic device may transmit a command indicating the update of the fourth block 518 to the first electronic device. The command may be transmitted to the first electronic device together with the fourth block 558.

In response to receiving a command indicating the update of the fourth block 518 from the second electronic device, the first electronic device according to an embodiment may update the fourth block 518 stored in the first electronic device using the fourth block 558 of cache data stored in the second electronic device. For example, the first electronic device may remove the fourth block 518 from the memory 510 and store the fourth block 558 obtained from the second electronic device in the memory 510. For example, the first electronic device may overwrite the fourth block 558 obtained from the second electronic device in a part where the fourth block 518 is stored in the memory 510.

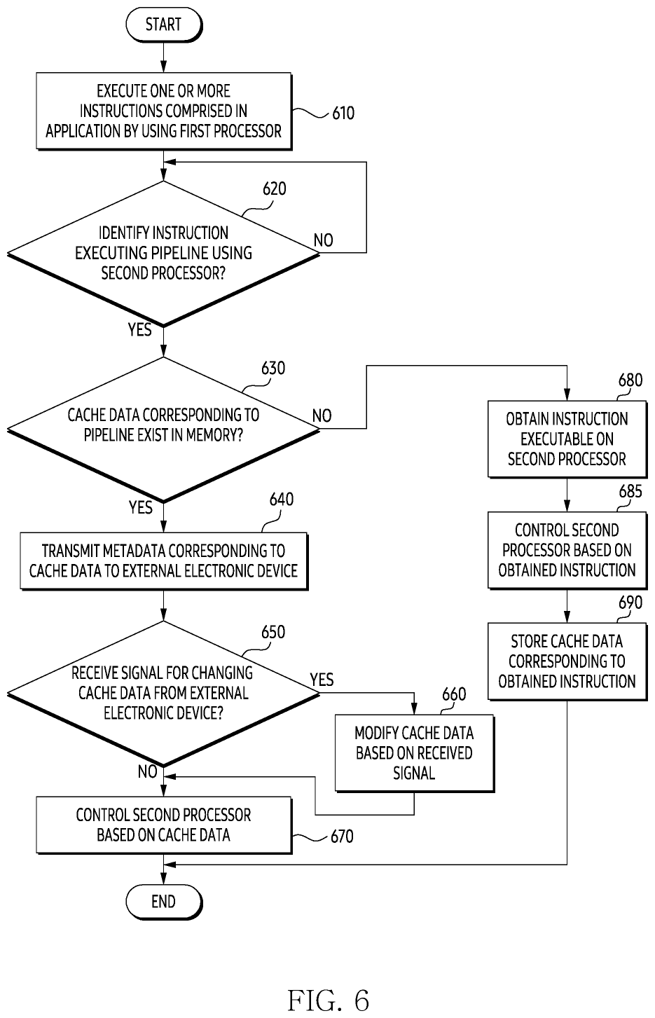

After performing the exchange of the block of cache data based on the communication connection established with the second electronic device, the first electronic device may control a pipeline of the second processor based on a block of cache data stored in the memory 510. Hereinafter, an operation in which the first electronic device controls the pipeline of the second processor will be described in detail with reference to FIG. 6.

FIG. 6 is a flowchart illustrating an operation performed by an electronic device to control a pipeline of a second processor according to an embodiment. The electronic device of FIG. 6 may comprise the electronic device 101 of FIGS. 1 to 2. At least one of the operations of FIG. 6 may be performed by the first processor 103 of FIG. 1.

Referring to FIG. 6, in operation 610, the electronic device according to an embodiment may execute one or more instructions comprised in an application using a first processor. The application may correspond to a preset application for providing a game service. The electronic device according to an embodiment may perform operation 610 in response to a user input for executing an application. For example, by executing one or more instructions related to an application and executable in the first processor from a memory (e.g., the memory 107 of FIG. 1), the electronic device may perform operation 610.

In a state of executing one or more instructions included in an application using the first processor, in operation 620, the electronic device according to an embodiment may identify instructions executing a pipeline (e.g., pipeline 420 of FIG. 4) using the second processor. The pipeline may be related to a second processor graphic pipeline and/or shader. The pipeline using the second processor may represent, for example, a series of operations for generating frame data to be output to the display (e.g., the display 109 of FIG. 1) of the electronic device.

The electronic device according to an embodiment may perform operation 620 in response to a preset event and/or entry into a state in a state in which the application is executed using the first processor based on operation 610. For example, the first processor may identify an instruction executing a pipeline using the second processor based on an API for generating an instruction executable by the second processor. The API is an instruction executable on the first processor, and may comprise, for example, an instruction causing compiling of the code by the first processor.

Until an instruction executing the pipeline using the second processor is identified (620-No), the electronic device according to an embodiment may maintain execution of one or more instructions on the first processor based on operation 610. In response to identification of an instruction executing a pipeline using the second processor (620-Yes), in operation 630, the electronic device according to an embodiment may determine whether cache data (e.g., cache data 410 of FIG. 4) corresponding to the pipeline exists in the memory. The electronic device according to an embodiment may search for cache data comprising instructions executable in the second processor in the memory based on operation 210 of FIG. 2 and/or operation 310 of FIG. 3. The cache data may be stored in the electronic device as shown in the example of FIG. 5.

The electronic device according to an embodiment may perform an operation of identifying cache data based on operation 630 using a thread independently executed from operations 610 and 620. For example, the electronic device may execute one or more instructions executable in the first processor based on operation 610 in the first thread such as the main thread executed in the first processor. In response to identifying instructions for executing a pipeline using a second processor by performing operation 620 using a first thread, the electronic device is executed in the first processor, and may perform operation 630 using a second thread distinct from the first thread. The electronic device may execute operation 630 independently of the first thread and time using the second thread. In a state in which the electronic device performs the operation 630 using the second thread, the electronic device may maintain performing the operations 610 and 620 using the first thread.

When cache data corresponding to the pipeline exists (630-Yes), in operation 640, the electronic device according to an embodiment may transmit metadata corresponding to the cache data to an external electronic device. For example, the electronic device may perform operation 640 based on operation 220 of FIG. 2 and/or operation 320 of FIG. 3. Metadata transmitted by the electronic device to an external electronic device may include at least one of the parameters in Table 1. In an embodiment in which the electronic device stores cache data based on a plurality of blocks, the electronic device may transmit metadata for each of the plurality of blocks to an external electronic device. The metadata may include at least one of information for identifying a pipeline corresponding to the cache data and/or a frequency of use of the pipeline.

The external electronic device (e.g., the electronic device 120 of FIGS. 1 to 2) that has received metadata corresponding to the cache data may identify a pipeline stored in the electronic device based on the received metadata. The external electronic device may transmit a signal related to a change of cache data stored in the electronic device by performing at least one of operations 230 and 240 of FIG. 2. For example, when the cache data stored in the external electronic device is the updated cache data of the cache data stored in the electronic device, the external electronic device may transmit a signal related to the change of the cache data to the electronic device. The signal transmitted by the external electronic device to the electronic device may comprise cache data stored in the external electronic device together with a command indicating a change in cache data. In an embodiment in which the electronic device stores cache data based on a plurality of blocks, the signal transmitted by the external electronic device to the electronic device may comprise a command to modify at least one of the blocks of the cache data.

After transmitting metadata corresponding to the cache data, in operation 650, the electronic device according to an embodiment may determine whether a signal for changing the cache data has been received from an external electronic device. The signal for changing the cache data may include a signal corresponding to a command related to updating the cache data.

When a signal for changing the cache data is received (650-Yes), in operation 660, the electronic device according to an embodiment may modify the cache data based on the received signal. For example, the electronic device may modify the cache data in the memory identified in operation 630 based on the cache data comprised in the received signal. The cache data comprised in the signal received by the electronic device from the external electronic device according to an embodiment may have a larger size than the cache data in the memory identified in operation 630. The cache data comprised in the signal received by the electronic device from an external electronic device according to an embodiment may have a later version than the cache data in the memory identified in operation 630. In an embodiment in which the electronic device stores cache data based on a plurality of blocks, the electronic device may modify at least one of blocks of cache data stored in the electronic device based on the received signal. The block of cache data changed by the electronic device may include one or more instructions for executing the pipeline identified in operation 620.

After not receiving a signal for changing the cache data (660-No), and/or changing the cache data based on operation 660, in operation 670, the electronic device according to an embodiment may control the second processor based on the cache data. The electronic device according to an embodiment may bypass the compiling of a code corresponding to the pipeline of operation 620 as a compiling performed by the first processor. The electronic device may input cache data identified in operation 630 and/or cache data changed by operation 660 to the second processor while bypassing the compiling.

The electronic device may cause execution of the pipeline of operation 620 in the second processor based on the input cache data. For example, the electronic device may initialize a shader using the graphic pipeline of the second processor based on one or more instructions comprised in the cache data. The electronic device may acquire frame data from the shader by inputting information comprising cache data to the initialized shader. In response to the acquisition of the frame data, the electronic device may output a screen corresponding to the frame data acquired on the display.

When cache data corresponding to the pipeline does not exist (630-No), in operation 680, the electronic device according to an embodiment may obtain instruction executable on the second processor. For example, the electronic device may obtain one or more instructions executable on the second processor from code encoded in the shader language using a driver program corresponding to the second processor being executed on the first processor. One or more instructions executable on the second processor among the first processor and the second processor may be generated by the compiling performed on the first processor.

In response to the acquisition of an instruction executable in the second processor, in operation 685, the electronic device according to an embodiment may control the second processor based on the obtained instruction. Controlling the second processor based on the instructions obtained by the electronic device may be performed similarly to controlling the second processor based on the instructions included in the cache data in operation 670. In an embodiment, when the cache data corresponding to the pipeline is not stored in the memory, the electronic device may stop bypassing the compiling in the first processor and perform the compiling in the first processor. The electronic device may obtain frame data to be output to the display by controlling the graphic pipeline in the second processor based on the compiled instruction.

Referring to FIG. 6, in operation 690, the electronic device according to an embodiment may store cache data corresponding to the obtained instruction. For example, in a state in which operation 685 is performed, the electronic device may generate one or more blocks of cache data by combining one or more instructions input to the second processor and information input to a shader executed by the one or more instructions. The electronic device may store the generated one or more blocks of cache data in a memory.

The electronic device may store metadata corresponding to the generated one or more blocks of cache data in a memory. The metadata may have an initialized frequency of use. After operation 690, whenever a block of cache data stored by operation 690 is called, the frequency of use of metadata corresponding to the called block may be gradually increased. The block of cache data stored by operation 690, after operation 690, may be identified by an external electronic device as at least one of operation 640, operation 320 of FIG. 3, or operation 220 of FIG. 2 is performed again by the electronic device. When the block of cache data stored in operation 690 has an updated version than the block of cache data stored in the external electronic device, the external electronic device may transmit a signal requesting upload of the block of cache data to the electronic device.

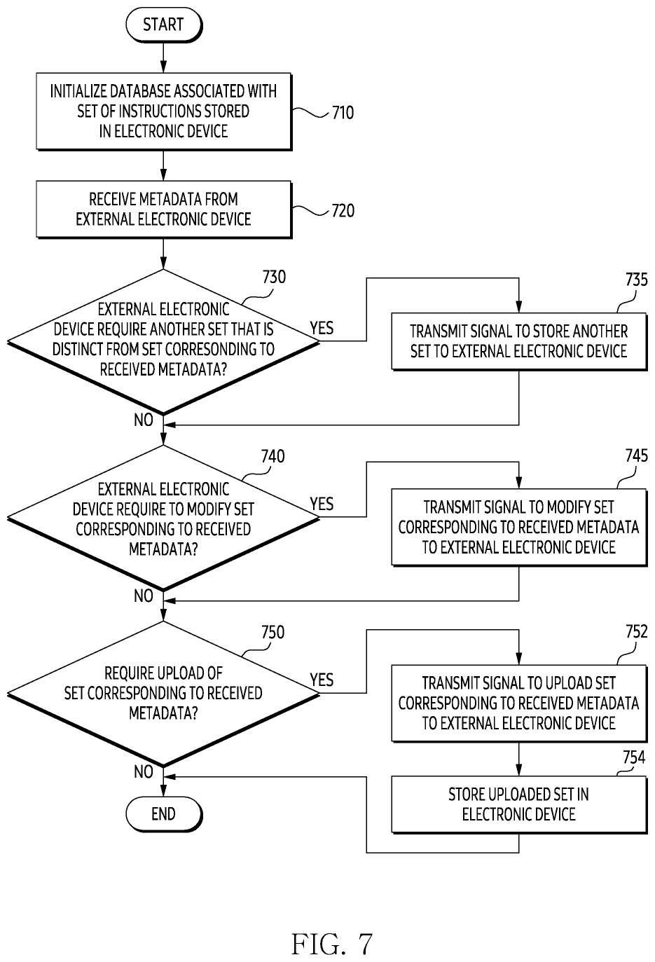

FIG. 7 is a flowchart of an electronic device according to an embodiment. The electronic device of FIG. 7 may comprise the electronic device 120 of FIGS. 1 and/or 2. At least one of the operations of FIG. 7 may be performed by the processor 122 of FIG. 1. At least one of the operations of FIG. 7 may be related to at least one of the operations of FIG. 2.

Referring to FIG. 7, in operation 710, the electronic device according to an embodiment may initialize a database associated with a set of instructions stored in the electronic device. The database initialized by the electronic device may be, for example, a database for managing a set of instructions (or blocks of cache data) stored in the electronic device based on at least one of the parameters in Table 1. The set of instructions may comprise one or more instructions executable on a processor (e.g., the second processor 105 of FIG. 1) such as a GPU of an external electronic device (e.g., the electronic device 101 of FIG. 1) connected to an electronic device and a combination of information corresponding to the one or more instructions.

Referring to FIG. 7, in operation 720, the electronic device according to an embodiment may receive metadata from an external electronic device. The metadata received by the electronic device may include one or more parameters describing a set of instructions of operation 710. The metadata may comprise, for example, at least one of the parameters in Table 1. The electronic device according to an embodiment may receive metadata from an external electronic device based on operation 230 of FIG. 2.

Referring to FIG. 7, in response to reception of metadata, the electronic device according to an embodiment may perform an operation related to a set of instructions stored in an external electronic device, such as operations 730, 740, and 750. The order in which the operations 730, 740, and 750 are executed is not limited to the example illustrated in FIG. 7, and for example, the operations 730, 740, and 750 may be performed independently of each other in the electronic device.

Referring to FIG. 7, in operation 730, the electronic device according to an embodiment may determine whether the external electronic device requires another set distinct from the set corresponding to the received metadata. For example, based on sets of instructions identified from an external electronic device based on metadata, the electronic device may identify the set with the highest executability among the sets different from the above sets in the external electronic device. When the set comprises the cache data 410 of FIG. 4, the electronic device may determine whether the external electronic device requires another set based on the hit rate and/or priority of the cache data.

When the external electronic device requires the other set (730-Yes), in operation 735, the electronic device according to an embodiment may transmit a signal for storing the other set to the external electronic device. The signal may comprise a command for instructing download of the other set by an external electronic device. The external electronic device receiving the signal may store another set comprised in the received signal, for example, based on operation 335 of FIG. 3.

Referring to FIG. 7, in operation 740, the electronic device according to an embodiment may determine whether the external electronic device requires to modify a set corresponding to the received metadata. For example, based on each version of the sets of external electronic devices recognized by metadata, the electronic device may identify one or more sets that require to be updated among the sets of external electronic devices.

When the external electronic device requires to modify the set (740-Yes), in operation 745, the electronic device according to an embodiment may transmit a signal for changing the set corresponding to the received metadata to the external electronic device. The signal may comprise a command for instructing an update of a set by an external electronic device. The external electronic device receiving the signal may update a set stored in the external electronic device, for example, based on operation 345 of FIG. 3.

Referring to FIG. 7, in operation 750, the electronic device according to an embodiment may determine whether a set corresponding to the received metadata is required to be uploaded. The electronic device according to an embodiment may identify a set not stored in the electronic device and/or a set having a later version than a set stored in the electronic device, among sets of external electronic devices recognized by metadata.

When uploading a set is required (750-Yes), in operation 752, the electronic device according to an embodiment may transmit a signal for uploading a set corresponding to the received metadata to the external electronic device. The signal may include a command indicating uploading of a set by an external electronic device. One or more sets may be transmitted to the electronic device based on the external electronic device receiving the signal, for example, operation 355 of FIG. 3.

After transmitting the signal, in response to receiving one or more sets from an external electronic device, in operation 754, the electronic device according to an embodiment may store a set uploaded in the electronic device. The electronic device may merge and store the uploaded set with another set stored in a memory (e.g., the memory 124 of FIG. 1). In response to the storage of the uploaded set, the electronic device may update the database of operation 710 based on the uploaded set. For example, the electronic device may store at least one of the parameters corresponding to the uploaded set in the database. The parameter may correspond to, for example, at least one of the parameters illustrated in Table 1.

As the electronic device according to an embodiment performs at least one of the operations of FIG. 7 with an external electronic device connected to the electronic device, the electronic device may continuously receive an updated set of instructions from the external electronic device. When the electronic device includes a server of a service provider, the electronic device may keep the set of instructions up to date using external electronic devices owned by each of the different subscribers. The electronic device according to an embodiment may cause the external electronic devices to bypass the compiling (e.g., run-time compiling of the application by the first processor 103 of FIG. 1) for obtaining the instructions by distributing a set of instructions maintained in the up-to-date state to the external electronic devices. As the external electronic devices bypass the compiling, delays caused by the compiling in the external electronic devices may be reduced.

FIG. 8 is a block diagram of an electronic device based on a cloud environment according to an embodiment. The electronic device 101 of FIG. 8 may comprise the electronic device 101 of FIGS. 1 and/or 2. The network switch 810 of FIG. 8, one or more gateways 820, one or more servers 830, and databases 840 and 850 may correspond to at least a part of the electronic device 120 of FIGS. 1 and/or 2.

Referring to FIG. 8, one or more servers 830 may share databases 840 and 850. Any one of the databases 840 and 850 may store information for managing one or more instructions executable in a processor (e.g., the second processor 105 of FIG. 1) such as a GPU in the electronic device 101 and a set (or blocks of cache data) of information to be input to a shader based on the one or more instructions. The other database among the databases 840 and 850 may store information necessary for executing a preset service such as a game.

When a user of the electronic device 101 executes an application related to a network-based game service, the electronic device 101 may access the network switch 810 based on the application. Through the network switch 810 and/or one or more gateways 820, the electronic device 101 may access one or more servers 830. The one or more servers 830 may perform, for example, at least one of the operations of FIG. 7 using one or more databases 840 and 850. A set of instructions collected from the electronic device 101 owned by each subscriber of the game service may be stored in the databases 840 and 850. The set of stored instructions may be distributed to the electronic device 101 and used to reduce delays caused by acquiring and/or compiling instructions in the electronic device 101.

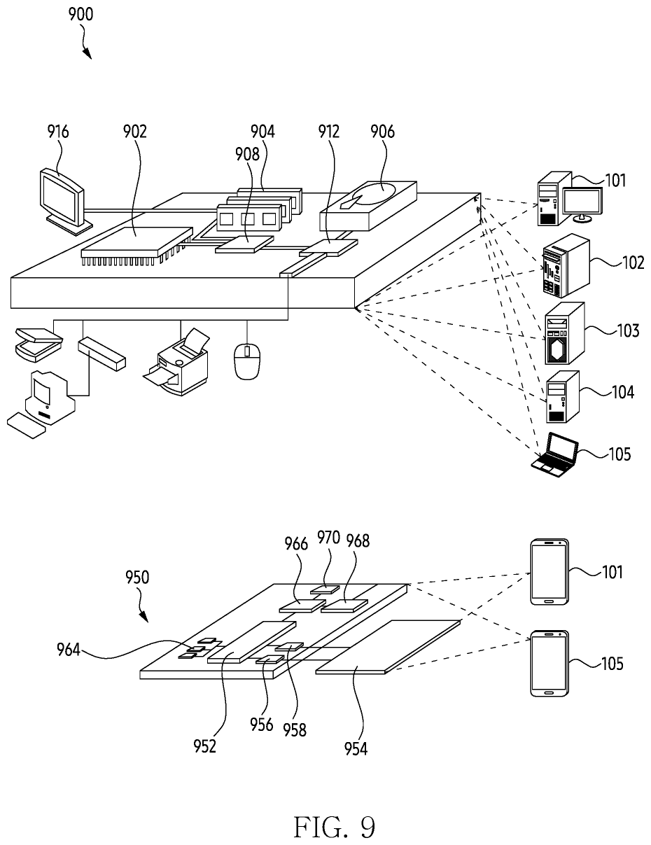

FIG. 9 is a simplified block diagram of electronic devices according to various embodiments. The electronic devices 101, 102, 103, 104, and 105 of FIG. 9 may correspond to the electronic device 101 of FIG. 1.

Referring to FIG. 9, the electronic device 900 may be an example of an electronic device 101, an electronic device 102, an electronic device 103, an electronic device 104, or an electronic device 105. The electronic device 900 may comprise a processor 902, a memory 904, a storage device 906, a high-speed controller 908 (e.g., northbridge), a MCH (Main Controller Hub), and a low-speed controller 912 (e.g., southbridge, ICH (I/O controller hub)). In the electronic device 900, each of the processor 902, the memory 904, the storage device 906, the high-speed controller 908, and the low-speed controller 912 may be interconnected using various buses.

For example, the processor 902 may process instructions for execution in the electronic device 900 to display graphic information about a GUI (graphical user interface) on an external input/output device such as a display 916 connected to the high-speed controller 908. The instructions may be comprised in the memory 904 or the storage device 906. The instructions, when executed by the processor 902, may cause the electronic device 900 to perform one or more of the operations described above. According to embodiments, the processor 902 may consist of a plurality of processors comprising a communication processor and a GPU (graphical processing unit).

For example, the memory 904 may store information in the electronic device 900. For example, the memory 904 may be a volatile memory unit or units. As another example, the memory 904 may be a nonvolatile memory unit or units. As another example, the memory 904 may be another type of computer-readable medium, such as a magnetic or optical disk.

For example, the storage device 906 may provide a mass storage space to the electronic device 900. For example, storage device 906 may be a computer-readable medium such as a hard disk device, an optical disk device, a flash memory, a solid-state memory device, or an array of devices in a SAN (storage area network).

For example, the high-speed controller 908 may manage bandwidth-intensive operations for the electronic device 900, while the low-speed controller 912 may manage low-bandwidth intensive operations for the electronic device 900. For example, the high-speed controller 908 is coupled to the memory 904 and coupled to the display 916 through a GPU or accelerator, while the low-speed controller 912 may be coupled to the storage device 906 and coupled to various communication ports (e.g., a USB(universal serial bus), a Bluetooth, a ethernet, a wireless ethernet) for communication with an external electronic device (e.g., a keyboard, a transducer, a scanner, or a network device (e.g., a switch or a router)).

The electronic device 950 may be an example of the electronic device 101 or the electronic device 105. The electronic device 950 may include a processor 952, a memory 964, an input/output device such as a display 954 (e.g., an OLED (organic light emitting diode) display or other suitable display), a communication interface 966, and a transceiver 968. Each of the processor 952, the memory 964, the input/output device, the communication interface 966, and the transceiver 968 may be interconnected using various buses.

For example, the processor 952 may process instructions included in the memory 964 to display graphic information on the GUI on the input/output device. The instructions may cause the electronic device 950 to perform one or more of the above-described operations when executed by the processor 952. For example, the processor 952 may interact with the user through a display interface 956 coupled to the display 954 and a control interface 958. For example, the display interface 956 may include a circuit for driving the display 954 to provide visual information to the user, and the control interface 958 may include a circuit for converting the commands to receive commands received from a user and provide the commands to the processor 952. According to embodiments, the processor 952 may be implemented as a chipset of chips including analog and digital processors.

For example, the memory 964 may store information in the electronic device 950. For example, the memory 964 may comprise at least one of one or more volatile memory units, one or more nonvolatile memory units, or computer-readable media.

For example, the communication interface 966, based on interworking with the processor 952, may perform wireless communication between the electronic device 950 and the external electronic device through various communication techniques such as cellular communication techniques, Wi-Fi communication techniques, NFC techniques, or Bluetooth communication techniques. For example, the communication interface 966 may be coupled to the transceiver 968 to perform the wireless communication. For example, the communication interface 966 may be further coupled to a GNSS (global navigation satellite system) reception module 970 to obtain location information of the electronic device 950.

A non-transitory computer readable medium according to various embodiments may store one or more programs, wherein the one or more programs may comprise instructions cause, when executed by a first processor of a first electronic device, the first processor to identify first instructions executable by a second processor of the electronic device distinct from the first processor, and stored in a memory of the first electronic device; transmit in response to identification of the first instructions, at least portion of information associated with the identified first instructions, to a second electronic device distinct from the first electronic device; receive a signal associated with the first instructions from the second electronic device, store in response to identification of second instructions distinct from the first instructions from the received signal and executable by the second processor, the second instructions in the memory and transmit in response to identification of a command indicating upload of the first instructions from the received signal, the first instructions executable by the second processor to the second electronic device.

In an embodiment, the one or more programs may further comprise instructions cause, when executed by a first processor, the first processor of the first electronic device to transmit in response to identification of the first instructions, the information including at least one of a time when the first instructions are compiled to be executable by the second processor, a size of the first instructions, identifier of content corresponding to the first instructions or a frequency in which the first instructions are used by the second processor, to second electronic device.

In an embodiment, the one or more programs may comprise instructions cause, when executed by a first processor, the first processor of the first electronic device to cause at least one of an identifier of a content corresponding to the first instructions, or the frequency in which the first instructions are used by the second processor to be included in a hash value in the information to be transmitted to the second electronic device.

In an embodiment, the one or more programs may comprise instructions cause, when executed by a first processor, the first processor of the first electronic device to Identify in the memory, the first instructions in a block corresponding to a state among distinct states of game service provided at least based on the one or more programs, wherein the block may comprise information to be inputted to a pipeline of the second processor corresponding to the first instructions when the first instructions are executed by the second processor.

In an embodiment, the one or more programs may comprise instructions cause, when executed by a first processor, the first processor of the first electronic device to store in the memory in response to identification of the second instructions, the identified second instructions aggregated with the first instructions.

In an embodiment, the one or more programs may comprise instructions cause, when executed by a first processor, the first processor of the first electronic device to substitute in response to identification of the second instructions, the first instructions stored in the memory based on the identified second instructions.

In an embodiment, the one or more programs may comprise instructions cause, when executed by a first processor, the first processor of the first electronic device to substitute in response to identification of a command for updating the first instructions from the received signal, the first instructions based on the second instructions.

In an embodiment, the one or more programs may comprise instructions cause, when executed by a first processor, the first processor of the first electronic device to transmit to the second processor in response to entering a preset state corresponding to the first instructions among multiple states of a game service provided at least based on the one or more programs, signal indicating execution of a pipeline based on the first instructions, modify information associated with an execution number of the pipelines based on the first instructions in the memory.

A non-transitory computer readable medium according to various embodiments may store one or more programs, wherein the one or more programs may comprise instructions cause, when executed by at least one processor of a first electronic device including a communication circuit, the first processor to receive by the communication circuit, information generated by the first processor of the second electronic device distinct from the first electronic device, identify first instructions, from the received information, corresponding to a first state among a plurality of states of a game service provided by the second electronic device, wherein the first instructions are stored in the second electronic device and executable by a second processor of the second electronic device distinct from the first processor, identify from a memory of the first electronic device in response to identification of the first instructions stored in the second electronic device, second instructions corresponding to the first state and executable by the second processor, transmit based on at least one of information of the identified first instructions or the identified second instructions, a signal including a command indicating upload of the first instructions to the second electronic device; and substitute in response to receiving of the first instructions from the second electronic device after the transmission of the signal, the second instructions stored in the memory based on the received first instructions.

In an embodiment, the one or more programs may comprise instructions cause, when executed by a first processor, the first processor of the first electronic device to identify the second instructions based on metadata including at least one of a size of the second instructions, an identifier of a game service corresponding to the second instructions, an identifier of the second processor, an identifier of an operating system of the second electronic device, a vendor identifier(ID) of the second electronic device, or an identifier of pipeline of the second processor corresponding to the second instructions.

In an embodiment, the metadata may further comprise a hash value including at least one of an identifier of a content corresponding to the second instructions, or a frequency in which the second instructions are used by the second processor.

In an embodiment, the one or more programs may comprise instructions cause, when executed by a first processor, the first processor of the first electronic device to identify, in the memory, the second instructions in a block corresponding to the first state, wherein the block may further comprise information to be inputted to a pipeline of the second processor corresponding to the second instructions when the second instructions are executed by the second processor of the second electronic device.

In an embodiment, the one or more programs may comprise instructions cause, when executed by a first processor, the first processor of the first electronic device to transmit in response to identification of the second instructions having a version former than a version of the first instructions that is indicated by the received information, the signal including the command indicating upload of the first instructions, and transmit in response to identification of the second instructions having a version latter than a version of the first instructions that is indicated by the received information, another signal including a command for substitution of the first instructions based on the second instructions to the second electronic device.

In an embodiment, the one or more programs may comprise instructions cause, when executed by a first processor, the first processor of the first electronic device to transmit in response to identification of the second instructions having a size smaller than a size of the first instructions that is indicated by the received information, the signal including the command indicating upload of the first instructions and transmit in response to identification of the second instructions having a size bigger than a size of the first instructions that is indicated by the received information, another signal including a command for substitution of the first instructions based on the second instructions to the second electronic device.

In an embodiment, the one or more programs may comprise instructions cause, when executed by a first processor, the first processor of the first electronic device to identify, from the memory of the first electronic device in response to identification of the first instructions corresponding to the first state, a third instructions corresponding to a second state that is distinct from the first state among the plurality of states, and having a priority, among an order of priorities respectively assigned to the plurality of the states, inferior to a priority of the first state and transmit in response to identification of the third instructions, the third instructions to the second electronic device.

According to various embodiments, a method of a first electronic device including a display, a memory, a communication circuit, a first processor and a second processor, wherein the first processor and the second processor execute distinct types of instructions, may comprise identifying by using the first processor, multiple sets of instructions, which are stored in the memory, and are executable by the second processor among the first processor and the second processor, and for displaying a screen in the display; transmitting, in response to identification of the multiple sets, metadata respectively corresponding to the multiple sets to a second electronic device distinct from the first electronic device by using the communication circuit; and upload, by using the first processor based on a signal transmitted from the second electronic device after transmission of the metadata, at least one of the multiple sets to the second electronic device.

In an embodiment, the metadata may include information indicating at least one of a size of a set corresponding to the metadata, or a version associated with a screen displayed in the display when the set corresponding to the metadata is executed by the second processor.

In an embodiment, each of the multiple sets may include, when executed by a second processor, at least one of instructions corresponding to one or more shaders included in a pipeline of the second processor, or information to be inputted to the one or more shaders.

The method of a first electronic device according to various embodiments may further comprise, downloading, by using the first processor based on the signal transmitted from the second electronic device after the transmission of the metadata, a set of instructions distinct from the multiple sets and executable by the second processor.

The method of a first electronic device according to various embodiments may further comprise, modifying, by using the first processor based on the signal transmitted from the second electronic device after the transmission of the metadata, a first set of multiple sets to a second set having a size bigger than a size of the first set.

The apparatus described above may be implemented as a combination of hardware components, software components, and/or hardware components and software components. For example, the devices and components described in the embodiments may be implemented using one or more general purpose computers or special purpose computers such as processors, controllers, arithmetical logic unit(ALU), digital signal processor, microcomputers, field programmable gate array (FPGA), PLU(programmable logic unit), microprocessor, any other device capable of executing and responding to instructions. The processing device may perform an operating system OS and one or more software applications performed on the operating system. In addition, the processing device may access, store, manipulate, process, and generate data in response to execution of the software. For convenience of understanding, although one processing device may be described as being used, a person skilled in the art may see that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, code, instruction, or a combination of one or more of them and configure the processing device to operate as desired or command the processing device independently or in combination. Software and/or data may be embodied in any type of machine, component, physical device, computer storage medium, or device to be interpreted by a processing device or to provide instructions or data to the processing device. The software may be distributed on a networked computer system and stored or executed in a distributed manner. Software and data may be stored in one or more computer-readable recording media.

The method according to the embodiment may be implemented in the form of program instructions that may be performed through various computer means and recorded in a computer-readable medium. In this case, the medium may continuously store a computer-executable program or temporarily store the program for execution or download. In addition, the medium may be a variety of recording means or storage means in which a single or several hardware are combined and is not limited to media directly connected to any computer system and may be distributed on the network. Examples of media may include magnetic media such as hard disks, floppy disks and magnetic tapes, optical recording media such as CD-ROMs and DVDs, magneto-optical media such as floppy disks, ROMs, RAMs, flash memories, and the like to store program instructions. Examples of other media include app stores that distribute applications, sites that supply or distribute various software, and recording media or storage media managed by servers.

Although embodiments have been described according to limited embodiments and drawings as above, various modifications and modifications are possible from the above description to those of ordinary skill in the art. For example, even if the described techniques are performed in a different order from the described method, and/or components such as the described system, structure, device, circuit, etc. are combined or combined in a different form from the described method or are substituted or substituted by other components or equivalents, appropriate results may be achieved.

Therefore, other implementations, other embodiments, and equivalents to the claims fall within the scope of the claims to be described later.

What is claimed is:

1. A non-transitory computer readable medium may store one or more programs, wherein the one or more programs comprise instructions that cause, when executed by a first processor of a first electronic device, the first processor to:
identify first instructions executable by a second processor of the electronic device distinct from the first processor, and stored in a memory of the first electronic device;
transmit, in response to identification of the first instructions, at least portion of information associated with the identified first instructions, to a second electronic device distinct from the first electronic device;
receive a signal associated with the first instructions from the second electronic device;
store, in response to identification of second instructions distinct from the first instructions from the received signal and executable by the second processor, the second instructions in the memory; and
transmit, in response to identification of a command indicating upload of the first instructions from the received signal, the first instructions executable by the second processor to the second electronic device.

2. The non-transitory computer readable medium of claim 1, wherein the one or more programs further comprise instructions that cause the first processor of the first electronic device to:
transmit, in response to identification of the first instructions, the information including at least one of a time when the first instructions are compiled to be executable by the second processor, a size of the first instructions, identifier of content corresponding to the first instructions or a frequency in which the first instructions are used by the second processor, to second electronic device.

3. The non-transitory computer readable medium of claim 2, wherein the one or more programs comprise instructions that cause, when executed by a first processor, the first processor of the first electronic device to:
cause at least one of an identifier of a content corresponding to the first instructions, or the frequency in which the first instructions are used by the second processor to be included in a hash value in the information to be transmitted to the second electronic device.

4. The non-transitory computer readable medium of claim 1, wherein the one or more programs comprise instructions that cause, when executed by a first processor, the first processor of the first electronic device to:
identify, in the memory, the first instructions in a block corresponding to a state among distinct states of game service provided at least based on the one or more programs,
wherein the block includes information to be inputted to a pipeline of the second processor corresponding to the first instructions when the first instructions are executed by the second processor.

5. The non-transitory computer readable medium of claim 1, wherein the one or more programs comprise instructions that cause, when executed by a first processor, the first processor of the first electronic device to:
store, in the memory in response to identification of the second instructions, the identified second instructions aggregated with the first instructions.

6. The non-transitory computer readable medium of claim 1, wherein the one or more programs comprise instructions that cause, when executed by a first processor, the first processor of the first electronic device to:
substitute, in response to identification of the second instructions, the first instructions stored in the memory based on the identified second instructions.

7. The non-transitory computer readable medium of claim 6, wherein the one or more programs comprise instructions that cause, when executed by a first processor, the first processor of the first electronic device to:
substitute, in response to identification of a command for updating the first instructions from the received signal, the first instructions based on the second instructions.

8. The non-transitory computer readable medium of claim 1, wherein the one or more programs comprise instructions that cause, when executed by a first processor, the first processor of the first electronic device to:
transmit, to the second processor in response to entering a preset state corresponding to the first instructions among multiple states of a game service provided at least based on the one or more programs, signal indicating execution of a pipeline based on the first instructions; and
modify information associated with an execution number of the pipelines based on the first instructions in the memory.

9. A non-transitory computer readable medium storing one or more programs, wherein the one or more programs comprise instructions that cause, when executed by at least one processor of a first electronic device including a communication circuit, the first processor to:
receive, by the communication circuit, information generated by the first processor of the second electronic device distinct from the first electronic device;
identify first instructions, from the received information, corresponding to a first state among a plurality of states of a game service provided by the second electronic device, wherein the first instructions are stored in the second electronic device and executable by a second processor of the second electronic device distinct from the first processor;
identify, from a memory of the first electronic device in response to identification of the first instructions stored in the second electronic device, second instructions corresponding to the first state and executable by the second processor;
transmit, based on at least one of information of the identified first instructions or the identified second instructions, a signal including a command indicating upload of the first instructions to the second electronic device; and
substitute, in response to receiving of the first instructions from the second electronic device after the transmission of the signal, the second instructions stored in the memory based on the received first instructions.

10. The non-transitory computer readable medium of claim 9, wherein the one or more programs comprise instructions that cause, when executed by a first processor, the first processor of the first electronic device to:
identify the second instructions based on metadata including at least one of a size of the second instructions, an identifier of a game service corresponding to the second instructions, an identifier of the second processor, an identifier of an operating system of the second electronic device, a vendor identifier (ID) of the second electronic device, or an identifier of pipeline of the second processor corresponding to the second instructions.

11. The non-transitory computer readable medium of claim 10, wherein the metadata further comprises a hash value including at least one of an identifier of a content corresponding to the second instructions, or a frequency in which the second instructions are used by the second processor.

12. The non-transitory computer readable medium of claim 9, wherein the one or more programs comprise instructions that cause, when executed by a first processor, the first processor of the first electronic device to:
identify, in the memory, the second instructions in a block corresponding to the first state,
wherein the block further comprise information to be inputted to a pipeline of the second processor corresponding to the second instructions when the second instructions are executed by the second processor of the second electronic device.

13. The non-transitory computer readable medium of claim 9, wherein the one or more programs comprise instructions that cause, when executed by a first processor, the first processor of the first electronic device to:
transmit, in response to identification of the second instructions having a version former than a version of the first instructions that is indicated by the received information, the signal including the command indicating upload of the first instructions; and
transmit, in response to identification of the second instructions having a version latter than a version of the first instructions that is indicated by the received information, another signal including a command for substitution of the first instructions based on the second instructions to the second electronic device.

14. The non-transitory computer readable medium of claim 9, wherein the one or more programs comprise instructions that cause, when executed by a first processor, the first processor of the first electronic device to:
transmit, in response to identification of the second instructions having a size smaller than a size of the first instructions that is indicated by the received information, the signal including the command indicating upload of the first instructions; and
transmit, in response to identification of the second instructions having a size bigger than a size of the first instructions that is indicated by the received information, another signal including a command for substitution of the first instructions based on the second instructions to the second electronic device.

15. The non-transitory computer readable medium of claim 9, wherein the one or more programs comprise instructions that cause, when executed by a first processor, the first processor of the first electronic device to:
identify, from the memory of the first electronic device in response to identification of the first instructions corresponding to the first state, a third instructions corresponding to a second state that is distinct from the first state among the plurality of states, and having a priority, among an order of priorities respectively assigned to the plurality of the states, inferior to a priority of the first state; and
transmit, in response to identification of the third instructions, the third instructions to the second electronic device.

16. A method of a first electronic device including a display, a memory, a communication circuit, a first processor and a second processor, wherein the first processor and the second processor execute distinct types of instructions, the method comprising:
identifying, by using the first processor, multiple sets of instructions, which are stored in the memory, and are executable by the second processor among the first processor and the second processor, and for displaying a screen in the display;
transmitting, in response to identification of the multiple sets, metadata respectively corresponding to the multiple sets to a second electronic device distinct from the first electronic device by using the communication circuit; and
uploading, by using the first processor based on a signal transmitted from the second electronic device after transmission of the metadata, at least one of the multiple sets to the second electronic device.

17. The method of claim 16, wherein the metadata includes information indicating at least one of a size of a set corresponding to the metadata, or a version associated with a screen displayed in the display when the set corresponding to the metadata is executed by the second processor.

18. The method of claim 16, wherein each of the multiple sets include, when executed by a second processor, at least one of instructions corresponding to one or more shaders included in a pipeline of the second processor, or information to be inputted to the one or more shaders.

19. The method of claim 16, further comprising downloading, by using the first processor based on the signal transmitted from the second electronic device after the transmission of the metadata, a set of instructions distinct from the multiple sets and executable by the second processor.

20. The method of claim 16, further comprising modifying, by using the first processor based on the signal transmitted from the second electronic device after the transmission of the metadata, a first set of multiple sets to a second set having a size bigger than a size of the first set.
